(19) United States
(12) Patent Application Publication
(10) Pub. No.: US 2022/0225152 A1
(43) Pub. Date: Jul. 14, 2022

(54) ADAPTIVE RADIO

(71) Applicant: SEMICONDUCTOR COMPONENTS INDUSTRIES, LLC, Phoenix, AZ (US)

(72) Inventors: Stephen Michael SCHULTZ, Danville, CA (US); Guobing TAN, Dublin, CA (US); Hojat Tollah KHELGHATI, San Jose, CA (US)

(73) Assignee: SEMICONDUCTOR COMPONENTS INDUSTRIES, LLC, Phoenix, AZ (US)

(21) Appl. No.: 17/572,874

(22) Filed: Jan. 11, 2022

Related U.S. Application Data
(60) Provisional application No. 63/136,408, filed on Jan. 12, 2021.

(51) Int. Cl. H04W 28/02; H04W 72/04; H04L 5/00

(52) U.S. Cl. CPC H04W 28/0215; H04W 72/048; H04L 5/0041; H04L 5/0007; H04W 72/0453

(57) ABSTRACT

One or more implementations may include operations that include obtaining, by a first device, second device information related to a capability of a second device with respect to operating in a first frequency band. The operations may also include causing an adaptive radio of the first device to transition between operating in the first frequency band and operating in a second frequency band based on the second device information.

### RELATED APPLICATIONS

The present application claims priority to U.S. Provisional Patent Application No. 63/136,408, filed on Jan. 12, 2021. The entire contents of which are incorporated by reference in the present disclosure.

### FIELD

The implementations discussed herein are related to an adaptive radio.

### BACKGROUND

Unless otherwise indicated herein, the materials described herein are not prior art to the claims in the present application and are not admitted to be prior art by inclusion in this section.

Wireless local area networks (WLAN) (e.g., Home, office, stadium, and outdoor networks) are often established using a device called a Wireless Access Point (WAP). The WAP may include a router. The WAP wirelessly couples devices of the local network, e.g. wireless stations such as: computers, printers, televisions, digital video (DVD) players, security cameras and smoke detectors to one another and to the Cable or Subscriber Line through which Internet, video, and television is delivered to the local network. Most WAPs implement the IEEE 802.11 standard which is a contention-based standard for handling communications among multiple competing devices for a shared wireless communication medium on a selected one of a plurality of communication channels. The frequency range of each communication channel is specified in the corresponding one of the IEEE 802.11 protocols being implemented, e.g. “a”, “b”, “g”, “n”, “ac”, “ad”, “ax”, “ay”, “be”. In addition, the frequency bands of which the channels are generally included are generally a 2.4 GHz band, a 5 GHZ band, and more recently a 6 GHz band.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example implementations described herein generally relate to an adaptive radio that dynamically transitions, during run-time, between operating in multiple frequency bands. Some implementations provide a method, system, and/or apparatus to facilitate the transitioning in a manner that allows for corresponding software and/or hardware to continue performing operations during the transitioning (e.g., a manner that may not require software and/or hardware resets or power cycling).

One or more implementations may include operations that include obtaining, by a first device, second device information related to a capability of a second device with respect to operating in a first frequency band. The operations may also include causing an adaptive radio of the first device to transition between operating in the first frequency band and operating in a second frequency band based on the second device information.

The present disclosure may be implemented in hardware, firmware, or software. Associated devices and circuits are also claimed. Additional features and advantages of the present disclosure will be set forth in the description which follows, and in part will be obvious from the present disclosure, or may be learned by the practice of the present disclosure. The features and advantages of the present disclosure may be realized and obtained by means of the instruments and combinations particularly pointed out in the appended claims. These and other features of the present disclosure will become more fully apparent from the following description and appended claims or may be learned by the practice of the present disclosure as set forth hereinafter.

### BRIEF DESCRIPTION OF THE DRAWINGS

Example implementations will be described and explained with additional specificity and detail through the use of the accompanying drawings in which:

FIG. 1A illustrates an example tri-band adaptive node configured to transition, during run-time, between multiple frequency bands, described according to at least one implementation of the present disclosure.

FIG. 1B includes a Table 1 of the Unlicensed National Information Infrastructure (UNII) channels.

FIG. 1C illustrates example frequency responses of bandpass filters that may be included in the adaptive node of FIG. 1A, according to at least one implementation of the present disclosure.

FIG. 2 illustrates an example wireless communication scenario that may be encountered by an adaptive mesh node, described according to at least one implementation of the present disclosure.

FIG. 3 illustrate an example flowchart of an example method of establishing a mesh backhaul link, described according to at least one implementation of the present disclosure.

FIG. 4 illustrates an example process of establishing a wireless mesh backhaul link, described according to at least one implementation of the present disclosure.

FIG. 5 illustrates an example flowchart of an example method of transitioning an adaptive radio between operating in multiple frequency bands, described according to at least one implementation of the present disclosure.

FIG. 6 illustrates a block diagram of an example computing system 602 that may be used to perform or direct performance of one or more operations described according to at least one implementation of the present disclosure.

### DETAILED DESCRIPTION OF SOME EXAMPLE IMPLEMENTATIONS

When communicating over more established standards, such as 802.11, 802.11a, 802.11b, 802.11g, 802.11-2007, 802.11n, 802.11ac, 802.11af, 802.11ax, etc., different frequency bands may be used. For example, channels may be allocated within a 2.4 gigahertz (GHz) band or a 5 GHz band. More recently, channels may also be allocated within a 6 GHz band. Communications within the 6 GHz band may also have different communication protocols that may be not be compatible with those performed in the 2.4 and 5 GHz bands. As such, many legacy devices may not be able to perform communications over the 6 GHz band, which can cause network compatibility and performance issues.

For example, a wireless local area networks (WLAN) may be managed by a set of mesh nodes (e.g., gateways, routers, repeaters, access points, etc.) that establish the WLAN as a mesh network. The mesh nodes may communicate with each other via backhaul connections to coordinate communications with client devices that may be conducted via fronthaul connections. Further, under some standards (e.g., 802.11ax) the 6 GHz band may be a preferred or optimal band for backhaul communications. However, some legacy mesh nodes may not be designed to support 6 GHz connections and communications according to 802.11ax and may accordingly perform backhaul communications with mesh nodes that do support 6 GHz connections (referred to herein as “tri-band mesh nodes”) via the 5 GHz band. However, doing so may cause tri-band mesh nodes to share the 5 GHz band for fronthaul communications and the 6 GHz band to be underutilized or completely unused when there are no 6 GHz client devices available.

Therefore, according to one or more implementations of the present disclosure, an adaptive radio may be used in a management node of a WLAN (e.g., a tri-band mesh node to allow for more flexibility in communications with legacy management nodes). As explained in detail below, the adaptive radio may be able to transition between 6 GHz communications and high band 5 GHz communications during run-time in which corresponding hardware or software continues executing operations during the transition without having to reset the corresponding hardware or software or perform a power cycle. The adaptive radio may accordingly transition between bands in a manner that may provide for adaptive backhaul communications by a tri-band AP that allows for better backwards compatibility and improved performance with legacy management nodes.

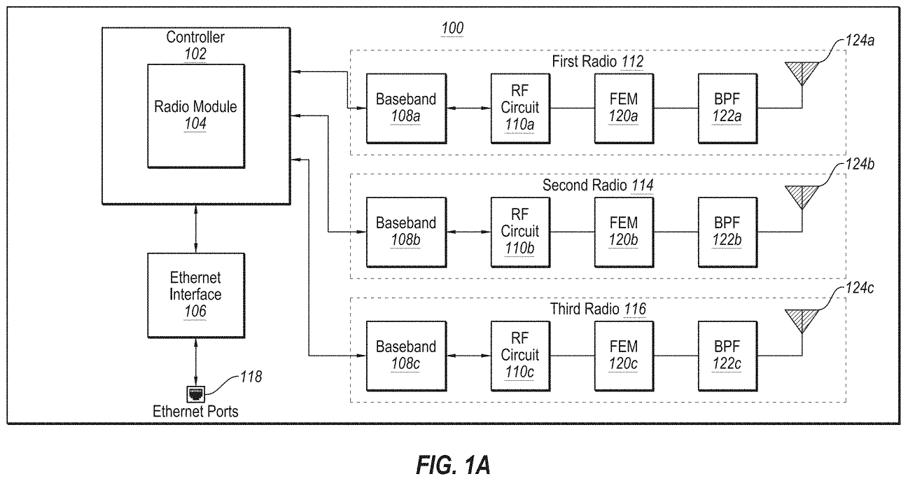

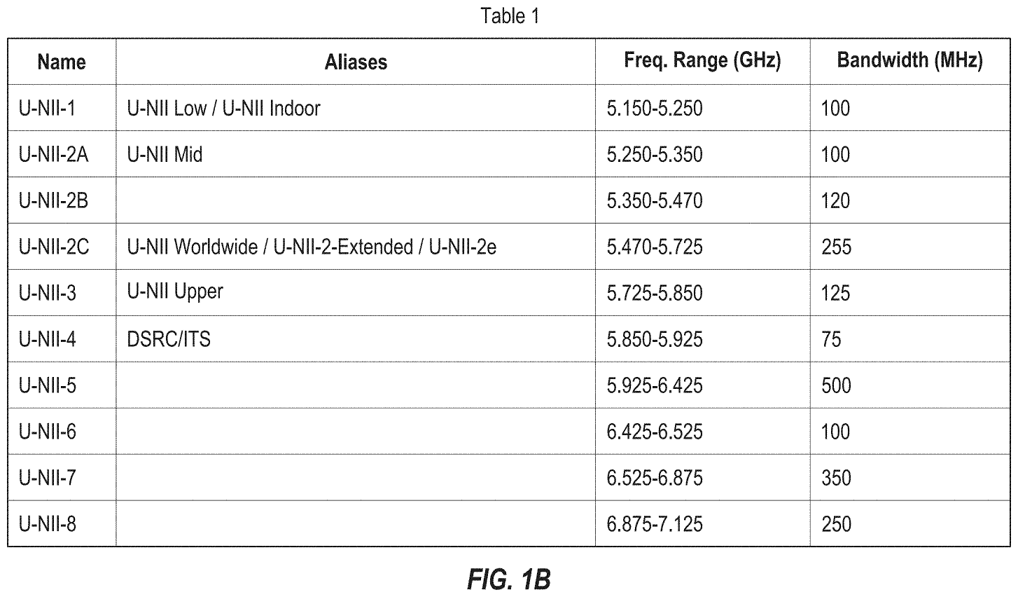

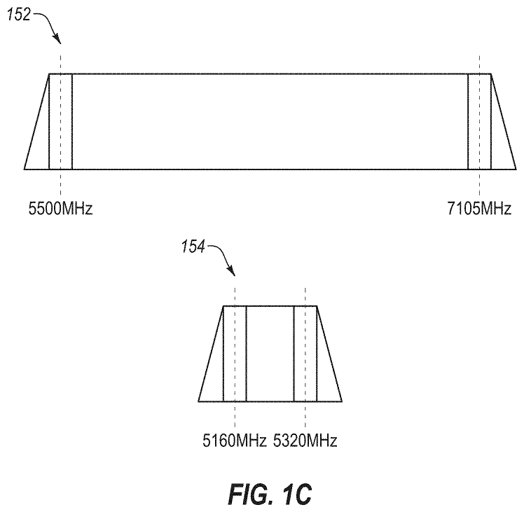

FIG. 1A illustrates an example tri-band adaptive node 100 (“adaptive node 100”) configured to transition, during run-time, between multiple frequency bands, according to one or more implementations of the present disclosure. In general, the adaptive node 100 may be configured to transition between the frequency bands in a dynamic manner that does not require resetting any software or hardware or performance of a power cycle.

The adaptive node 100 may include any suitable system, apparatus, or device that may be configured to establish a wireless local area network (WLAN) and/or provide access to the WLAN of one or more client devices of the WLAN. Examples of the adaptive node 100 may include a router, a gateway, a repeater, a mesh node, and/or any other suitable access point for a client device. The client devices may generally include any device that has the capability to wirelessly connect to the adaptive node 100 (e.g., according to any of the 802.11 standards or other suitable wireless standard). By way of example, the client devices may include a desktop computer, a laptop computer, a tablet computer, mobile phone, a smartphone, a personal digital assistant (PDA), a smart television, an Internet of Things (IoT) device, a Virtual Reality (VR) headset, or any other suitable wireless station.

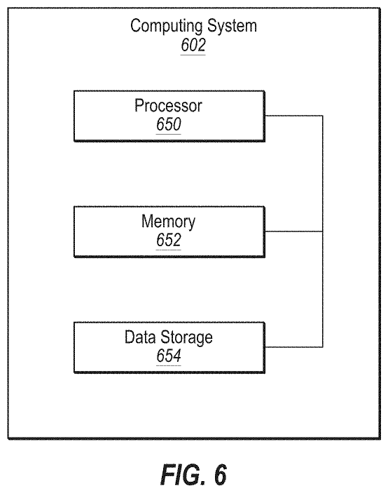

The adaptive node 100 may include: a controller 102 (e.g., a computer system), an Ethernet interface 106, one or more Ethernet ports 118, a first radio 112, a second radio 114, and additional radios (e.g., a third radio 116). The controller 102 may include any suitable system configured to perform or direct performance of operations of the adaptive node 100. An example controller 102 as a computer system is described with respect to FIG. 6.

In some implementations, the controller 102 may include a radio module 104. The radio module 104 may include instructions (e.g., code) and routines configured to enable the controller 102 to perform one or more operations. Additionally or alternatively, the radio module 104 may be implemented using hardware including a processor, a microprocessor (e.g., to perform or control performance of one or more operations), a field-programmable gate array (FPGA), or an application-specific integrated circuit (ASIC). In some other instances, the radio module 104 may be implemented using a combination of hardware and software. In the present disclosure, operations described as being performed by radio module 104 may include operations that the radio module 104 may direct a corresponding system (e.g., the controller 102 and/or the adaptive node 100) to perform. As discussed in further detail below, the radio module 104 may be configured to direct the first radio 112 to transition between operating in the first frequency band and the second frequency band.

The Ethernet interface 106 may include any suitable system, apparatus, or device configured to provide an interface between the Ethernet ports and the controller 102. For example, the Ethernet interface 106 may include an Ethernet PHY, which may be a physical layer transceiver device for sending and receiving Ethernet frames based on the Open Systems Interconnection network model. In these or other implementations, the Ethernet interface 106 may include one or more transformers configured to isolate incoming Ethernet signals that may be received at the Ethernet ports 118. In these or other implementations, the controller 102 may be configured to process the received Ethernet signals and perform operations accordingly.

The first radio 112 may be configured as an adaptive radio and may include a set of components that are configured to alternate between performing communications in multiple frequency bands. In the example implementation, the first radio 112 may be configured to alternate between performing communications in a first frequency band and performing communications in a second frequency band. In these or other implementations, the first radio 112 may be configured such that the transition may happen dynamically during run-time while continuing hardware and/or software operations that are performed during run-time (e.g., avoiding hardware and/or software resets).

The second radio 114 may include a set of components that are configured to operate in a third frequency band that is different from the frequency bands associated with the first radio 112 (e.g., the first frequency band and the second frequency band). The third radio 116 may include a set of components that are configured to operate in a fourth frequency band that is different from the frequency bands associated with the first radio 112 (e.g., first frequency band, the second frequency band) and the third frequency band.

By way of example, in some implementations, the first frequency band may correspond to the 6 GHz band of the 802.11 standard. Additionally or alternatively, the second frequency band may correspond to a high portion of the 5 GHz band of the 802.11 standard. Additionally or alternatively, the third frequency band may correspond to a low portion of the 5 GHz band of the 802.11 standard. Additionally or alternatively, the fourth frequency band may correspond to the 2.4 GHz band of the 802.11 standard.

Additionally, the 5 GHz band and the 6 GHz band may each include a set of sub-bands (also referred to as channels) that are divided according to the Unlicensed National Information Infrastructure (UNII). The corresponding sub-bands may be referred to as “UNII channels” in the present disclosure. The UNII channels may include 10 different channels and are indicated in Table 1 of FIG. 1B. In some implementations, the 5 GHz band may include UNII channels UNII-1, UNII 2A, UNII-2C, and UNII-3. The 6 GHz band may include UNII channels UNII-5 through UNII-8.

In some implementations, the first frequency band may accordingly include UNII channels UNII-5 through UNII-8. Additionally, the second frequency band may include UNII channels UNII-2C and UNII-3. The third frequency band may include UNII channels UNII-1 and UNII-2A. The above correspondences between frequency bands and UNII channels are merely given as examples. Different and/or additional UNII channels may correspond to different frequency bands depending on the implementation. For example, in some implementations, the second frequency band may also include UNII channel UNII-2B and/or UNII channel 4.

In general, the first radio 112 may include a baseband circuit 108a, an RF circuit 110a, a front-end module (FEM) 120a, a bandpass filter (BPF) 122a, and an antenna 124a. The second radio 114 may similarly include a baseband circuit 108b, an RF circuit 110b, a FEM 120b, BPF 122b, and an antenna 124b. In addition, the third radio 116 may similarly include a baseband circuit 108c, an RF circuit 110c, a FEM 120c, a BPF 122c, and an antenna 124c.

In general, the baseband circuits 108 may include any suitable system, apparatus, or device configured to process wireless communications that may be received or transmitted by the adaptive node 100. For example, each baseband circuit 108a-108c may include one or more equalizers, one or more automatic gain controllers, one or more encoders (e.g., a forward error correction (FEC) encoder), one or more decoders (e.g., a FEC decoder), one or more bit interleavers, one or more constellation mappers, one or more precoders, one or more bit deinterleavers, one or more constellation demappers, and/or other suitable circuit elements. The baseband circuits 108 may each include any suitable configuration of software, hardware, or combination of both.

Further, the baseband circuit 108a may be configured to support communications in the first frequency band and the second frequency band such that the baseband circuit 108a may transition between supporting communications in the first frequency band to supporting communications in the second frequency band.

In some implementations, the baseband circuit 108a may accordingly be configured to support communications over UNII channels UNII-2C through UNII 8. For example, the baseband circuit 108a may include multi-mode software and/or hardware that is able to switch between operating in a first mode that supports the first frequency band (e.g., UNII channels UNII-5 through UNII-8) and operating in a second mode that supports the second frequency band (e.g., UNII channels UNII-2C and UNII-3).

In these or other implementations, the baseband circuit 108b may be configured to support communications over the third frequency band. For instance, the baseband circuit 108b may include software and/or hardware that supports RF specifications and communications for operating in the third frequency band (e.g., UNII channels UNII-1 through UNII-2A). Although described and illustrated as two separate baseband circuits, in some implementations, the baseband circuit 108a and the baseband circuit 108b may be a same baseband circuit. For example, such a baseband may include software and/or hardware that supports RF specifications and communications for UNII channels UNII-1 through UNII-8. Additionally or alternatively, such a baseband circuit may include a same software (e.g., implemented as firmware) that is configured to transition between the two communication protocols that are associated with the first frequency band and the second frequency band during run-time operations. In these or other implementations, such a baseband circuit may be configured to support communications over the third frequency band while also supporting communications over the first frequency band or the second frequency band and transitioning between such communications.

Additionally or alternatively, the baseband circuit 108c may be configured to support communications over the fourth frequency band. For example, in some implementations, the baseband circuit 108c may include software and/or hardware that supports RF specifications and communications for 802.11 communications performed over the 2.4 GHz band. In these or other implementations, the baseband circuit 108c may be combined with the baseband circuit 108a and/or 108b to form a single baseband circuit.

Each of the RF circuits 110 may be configured to upconvert wireless transmissions initiated in a corresponding baseband circuit 108 and intended for transmission by their corresponding radios 112, 114, 116. Each of the RF circuits 110 may also be configured to downconvert incoming transmissions received by its corresponding radio. Each of the RF circuits 110 may include one or more analog-to-digital converters (ADCs), one or more digital-to-analog converters (DACs), one or more RF filters, one or more upconverters, one or more downconverters, and/or other suitable circuit elements. The RF circuits 110 may include any suitable configuration of software, hardware, or combination of both.

Further, each of the RF circuits 110 may be configured to operate with respect to a particular frequency range that corresponds to the band for which a corresponding radio may be configured. For example, as indicated above, the first radio 112 may be configured to transition between the first frequency band and the second frequency band. As such, the RF circuit 110a may be configured to operate with respect to a particular frequency range that includes the first frequency band and the second frequency band. In these or other implementations, the RF circuit 110a may be configured to dynamically operate within the particular frequency range to dynamically select (e.g., during run-time) between operating with respect to the first frequency band or the second frequency band. For instance, the RF circuit 110a may include a single bill of materials (BOM) file that allows for dynamically transitioning between the first frequency band or the second frequency band.

The RF circuit 110b may be similarly configured to operate with respect to the third frequency band that corresponds to the second radio 114. Further, the RF circuit 110c may be configured to operate with respect to the fourth frequency band that corresponds to the third radio 116.

Although the RF circuits 110 are illustrated as three separate circuits in the present disclosure, two or more of the RF circuits 110 may be combined into a single RF circuit that has the functionality of the respectively combined RF circuits 110. For example, in some implementations, the RF circuits 110a and 110b may be part of a single, wideband RF circuit that may be configured to operate with respect to frequency ranges that correspond to the first frequency band, the second frequency band, and the third frequency band. In these or other implementations, this combined RF circuit may be configured to have a dynamic operation that is configurable to work on any channel in any of the corresponding frequency bands during run-time operations (e.g., may include a single BOM file that allows for dynamically transitioning between channels of the first frequency band, the second frequency band, and the third frequency band without resetting the RF circuit such that run-time operations may continue and not be disrupted).

As another example, in some implementations, the RF circuits 110a, 110b, and 110c may be part of a single, wideband RF circuit that may be configured to operate with respect to frequency ranges that correspond to the first frequency band, the second frequency band, the third frequency band, and the fourth frequency band. Such a combined RF circuit may also be configured to have a dynamic operation that is configurable to work on any channel of the corresponding frequency bands. Further, in some implementations, two or more of the controller 102, one or more of the baseband circuits 108, and/or one or more of the RF circuits 110 may be integrated together on a same chip or may be included on separate chips.

In general, each FEM 120 may include one or more analog circuit elements to process RF transmissions outbound from a corresponding RF circuit 110 or RF transmissions inbound to the corresponding RF circuit 110. By way of example, the FEMs 120 may each include one or more phase controllers, one or more RF controllers, one or more mixers, one or more gain elements such as one or more low noise amplifiers (LNAs), and/or other suitable circuit elements. In these or other implementations, the components of the FEMs 120 may be configured to operate in frequency ranges that correspond to their particular radios (e.g., first radio 112, second radio 114, and third radio 116).

For example, the components of the FEM 120a may be configured to operate in frequency ranges that include the first frequency band and the second frequency band. Similarly, the components of the FEM 120b may be configured to operate in frequency ranges that include the third frequency band and the components of the FEM 120c may be configured to operate in frequency ranges that include the fourth frequency band.

In general, each BPF 122 may include any suitable configuration of components configured to operate as a bandpass filter. In these or other implementations, the passband of each BPF 122 may correspond to the frequency range of its associated radio. For example, the BPF 122a of the first radio 112 may be configured such that its passband may correspond to the first frequency band and the second frequency band, the BPF 122b of the second radio 114 may be configured such that its passband may correspond to the third frequency band, and the BPF 122c of the third radio 116 may be configured such that its passband may correspond to the third frequency band. In some implementations, the BPF 122a may have a wider passband than the BPF 122b and/or the BPF 122c to support the wider range of frequencies that may be associated with transitioning between the first frequency band and the second frequency band.

For example, FIG. 1C illustrates an example frequency response 152 of the BPF 122a in instances in which the first frequency band and the second frequency band collectively correspond to UNII channels UNII-2C through UNII-8. FIG. 1C also illustrates an example frequency response 154 of the BPF 122b in instances in which the third frequency band correspond to UNII channels UNII-1 through UNII-2A. As indicated by a comparison between the frequency responses, the passband of the BPF 122a may be wider than the passband of the BPF 122b.

As indicated above, each of the radios 112, 114, 116 may also include a respective antenna 124. Each antenna 124 may be configured with respect to the frequency band of its respective radio. For example, the antenna 124a of the first radio 112 may be tuned according to the frequencies of the first frequency band and the second frequency band. Similarly, the antenna 124b of the second radio 114 and the antenna 124c of the third radio 116 may be respectively tuned according to the frequencies of the third frequency band and the fourth frequency band.

As indicated above, in some implementations, the radio module 104 may be configured to direct operations of the first radio 112 with respect to transitioning between operating in the first frequency band or the second frequency band. For example, the radio module 104 may be configured to direct the baseband circuit 108a and the RF circuit 110a to operate in the first mode with respect to the first frequency band or operate in the second mode with respect to the second frequency band. The operation in the first mode by the baseband circuit 108a may include performing baseband operations for communication of signals in the first frequency band according to communication protocols associated with the first frequency band. Additionally or alternatively, the operation in the first mode by the RF circuit 110a may include performing corresponding operations for communication of signals in the first frequency band according to the communication protocols associated with the first frequency band. Similarly, the baseband circuit 108a and the RF circuit 110a may perform corresponding operations for communication of signals in the second frequency band according to the communication protocols associated with the second frequency band while operating in the second mode.

In these or other implementations, the radio module 104 may be configured to intelligently select between directing the adaptive radio to operate in the first mode or the second mode with respect to wirelessly communicating with one or more devices over a wireless network. In these or other implementations, the selection may be based on the respective capabilities of the one or more other devices with respect to being able to operate in the first frequency band.

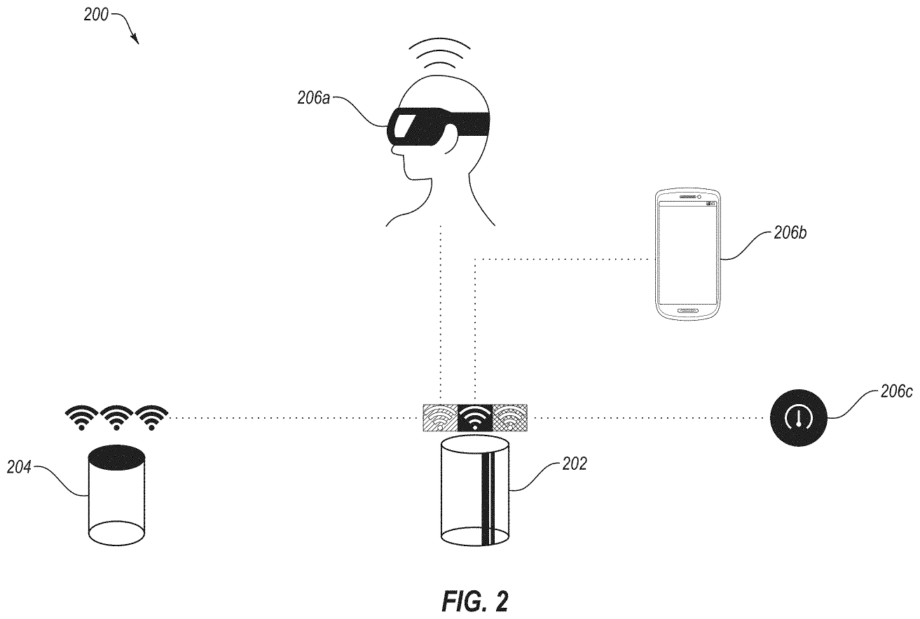

In these or other implementations, the radio module 104 may be configured to determine whether and/or how to use the first frequency band or the second frequency band for backhaul or fronthaul communications based on the respective capabilities of the one or more other devices, based on the types of the one or more other devices, and/or based on how much the first frequency band or the second frequency band are being utilized. Additionally or alternatively, the radio module 104 may be configured to determine whether and/or how to use the third frequency band and/or the fourth frequency band for backhaul or fronthaul communications based on the respective capabilities of the one or more other devices, based on the types of the one or more other devices, and/or based on how much the third frequency band or the fourth frequency band are being utilized. Further examples of scenarios and selections of different modes are given below with respect to FIG. 2.

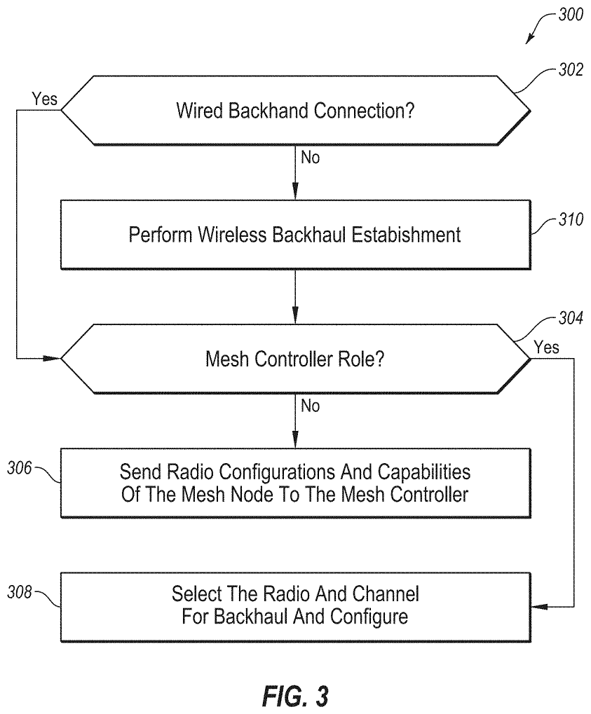

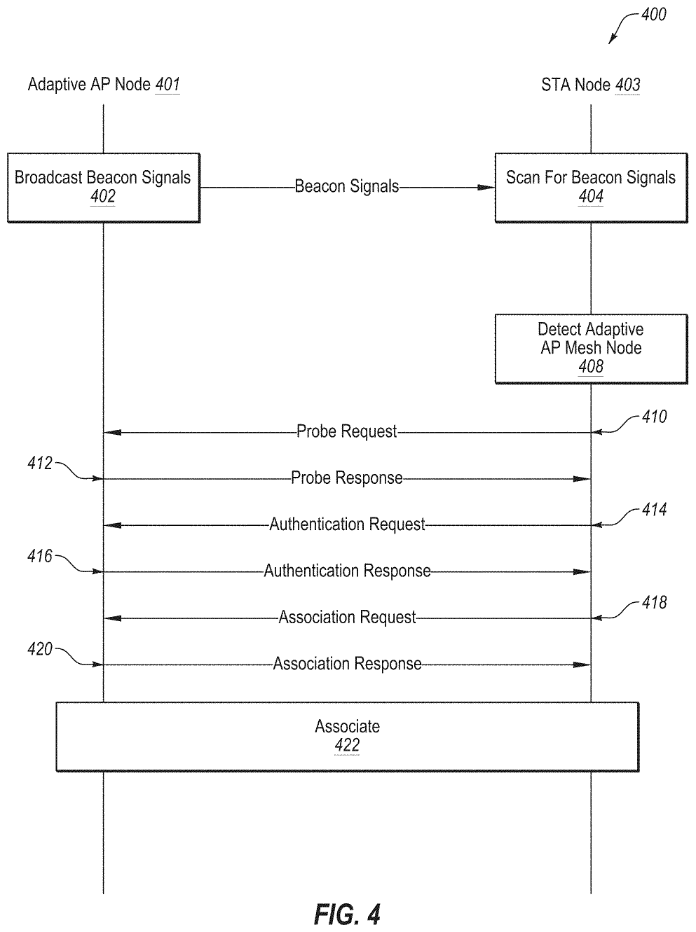

In some implementations, the radio module 104 may be configured to determine the respective capabilities of the one or more other devices with respect to operating in the different frequency bands according to any suitable technique. For example, in some implementations, the adaptive node 100 may be a mesh node and may determine the communication capabilities of one or more other mesh nodes based on wired backhaul communications (e.g., performed via the Ethernet interface 106 and one or more of the Ethernet ports 118). Additionally or alternatively, beacon signals may be used to determine the communication capabilities of one or more other devices with respect to the different frequency bands. In these or other implementations, the wired backhaul communications and/or beacon signals may be used to determine frequency band communication capabilities of one or more other mesh nodes as part of establishing one or more mesh backhaul links. Some examples of establishing mesh backhaul links are given below with respect to FIGS. 3 and 4.

Modifications, additions, or omissions may be made to FIGS. 1A-1C without departing from the scope of the present disclosure. For example, one or more of the first radio 112, the second radio 114, or the third radio 116 may be configured to perform multiple-input multiple-output (MIMO) communications. For instance, any suitable MIMO configuration may be applicable including a 2×2 configuration, a 3×3 configuration, a 4×4 configuration, etc. Further, although the first radio 112 is described in the context of an adaptive node that may maintain or establish a WLAN, the first radio 112 and an analogous radio module may be included in any suitable client device to allow for the client device to transition between operating in the first frequency band and the second frequency band. In these or other implementations, such a client device may include the second radio 114 and/or the third radio 116. Further, the passbands of the BPF's may vary from those described depending on certain implementations.

In addition, as indicated above, the example frequency ranges given with respect to the different frequency bands are not necessarily limiting. For instance, the UNII channels that correspond to the first frequency band and/or the second frequency band may vary depending on different implementations. As another example, even though some frequency bands are indicated as being a 2.4 GHz band, a 5 GHz band, or a 6 GHz band, each of these generally referred to bands may include a range of frequencies that are not exactly these particular frequencies. In addition, any number of other frequency bands may be included. For instance, in some implementations, the first frequency range may include the 6 GHz band and a 7 GHz band.

Moreover, in some implementations, the radio module 104 may not only be configured to direct which frequency bands may be used for wireless communications performed by the adaptive node 100, but may also be configured to direct which frequency bands may be used for wireless communications performed by other nodes and/or client devices. For example, in some implementations, the adaptive node 100 may operate as a mesh controller that may control one or more other mesh nodes that may establish and/or maintain the WLAN. In these or other implementations, the radio module 104 may determine which frequency bands may be used by the other mesh nodes for their respective wireless communications based on the wireless communication and associated frequency band capabilities of the other mesh nodes and the other mesh nodes and/or client devices with which each of the other mesh nodes are wirelessly connected. In these or other implementations, the radio module 104 may accordingly control which frequency band mode may be used by corresponding adaptive radios of the other mesh nodes or client devices. Additionally or alternatively, the radio module 104 may control transitions between the frequency band modes of the adaptive radios.

Further, the examples given with respect to the first radio 112 with respect to transitioning between operating in the first mode for performing communications using the first frequency band and operating in the second mode for performing communications using the second frequency band are not meant to be limiting. The first radio 112 may be configured to transition between any number of modes associated with any number of frequency bands depending on specific implementations. Additionally, in some embodiments, the adaptive node 100 may include fewer or more radios than those described and depicted. Further, in these or other embodiments, the adaptive node 100 may include multiple adaptive radios, which may each be configured for different multiple frequency bands. Additionally or alternatively, two or more of the adaptive radios may be configured for the same frequency bands.

FIG. 2 illustrates an example wireless communication scenario 200 that may be encountered by an adaptive mesh node 202 (“adaptive node 202”), according to one or more implementations of the present disclosure. The adaptive node 202 may be analogous to the adaptive node 100 of FIG. 1A. In the example scenario 200, different frequency bands may be used for the wireless communications. The multiple different frequency bands may include, for example, a first frequency band, a second frequency band, a third frequency band, and/or a fourth frequency band. In some implementations and in the example scenario 200, the first frequency band may include the 802.11 6 GHz band, the second frequency band may include the 802.11 high 5 GHz band (e.g., UNII channels UNII-2C and UNII-3), the third frequency band may include the 802.11 low 5 GHz band (e.g., UNII channels UNII-1 and UNII-2A), and the fourth frequency band may include the 802.11 2.4 GHz band. However, as also indicated above, such frequencies for the different frequency bands are merely given as examples such that the different frequency bands are not necessarily limited to the specifically given example frequencies.

In the example scenario 200, the adaptive node 202 may perform wireless communications with a mesh node 204, a first client device 206a (illustrated, by way of example, as a VR headset), a second client device 206b (illustrated, by way of example, as a mobile telephone), and a third client device 206c(illustrated, by way of example, as an IOT device). In general, the node 202 and the mesh node 204 may be configured to establish and maintain a WLAN and may conduct backhaul communications with each other as part of maintaining and establishing the WLAN. Additionally or alternatively, the node 202 may be configured to provide WLAN services to the client devices 206 via fronthaul communications. In scenario 200, the mesh node 204 and the first client device 206a may each be capable of 6 GHz, 5 GHz, and 2.4 GHz communications, the second client device 206b may be capable of 5 GHz and 2.4 GHz communications, and the third client device 206c may only be capable of 2.4 GHz communications. In some implementations, the adaptive node 202 may be configured to determine the frequency band capabilities of the mesh node 204 and/or any one of the client devices 206 via any suitable technique (e.g., via beacon signals, wired backhaul communications, etc.)

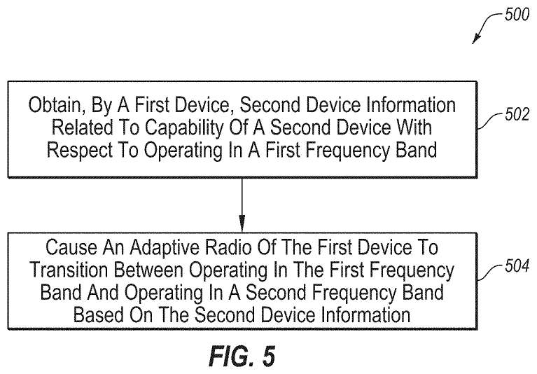

In some implementations, the adaptive node 202 may establish a 6 GHz backhaul wireless connection with the mesh node 204 in response to the mesh node 204 being capable of 6 GHz communications. For example, in response to the mesh node 204 being capable of 6 GHz communications, an adaptive radio of the adaptive node 202 may transition to operating in a first mode that corresponds to performing 6 GHz communications. Additionally or alternatively, the transition to the first mode may be from a second mode that corresponds to performing high band 5 GHz communications. In these or other implementations, the transition may maintain run-time operations without resetting of software and/or hardware of the adaptive node 202. In these or other implementations, the 6 GHz backhaul connection may be established using one or more operations described in further detail below with respect to FIGS. 4 and 5.

In these or other implementations, the adaptive node 202 may conduct wireless fronthaul communications with the first client device 206a. In some implementations, the adaptive node 202 may determine (e.g., via a radio module included therein) whether to conduct the fronthaul communications with the first client device via the 6 GHz band, the low 5 GHz band, or the 2.4 GHz band based on any suitable criteria or factors, such as channel quality within the respective bands, the amount of traffic currently being communicated over the respective bands, priority of communications with the first client device 206a, etc. It is noted that in some implementations, such a determination may not consider communications in the high 5 GHz band because the adaptive radio may be in the first mode and not the second mode. Additionally, in instances in which the 6 GHz band is used for fronthaul communications between the adaptive node 202 and the first client device 206a, the 6 GHz band may be shared with backhaul communications performed between the adaptive node 202 and the mesh node 204.

Additionally or alternatively, the adaptive node 202 may conduct wireless fronthaul communications with the second client device 206b. In some implementations, the adaptive node 202 may determine (e.g., via the radio module included therein) whether to conduct the fronthaul communications with the second client device via the low 5 GHz band (e.g., using another radio such as the second radio 114 of FIG. 1A) or the 2.4 GHz band (e.g., using another radio such as the third radio 116 of FIG. 1A) based on any suitable criteria or factors (e.g., channel quality, traffic amount, link prioritization, etc.). It is noted that in some implementations, such a determination may not select communications in the high 5 GHz band because the adaptive radio may be in the first mode and not the second mode as indicated above. Further, such a determination may determine not to perform communications in the 6 GHz band due to the second client device not having 6 GHz communication capabilities.

In these or other implementations, the adaptive node 202 may conduct wireless fronthaul communications with the third client device 206c via the 2.4 GHz band (e.g., via the third radio 116 of FIG. 1A). The determination to perform the wireless fronthaul communications via the 2.4 GHz band may be because the 2.4 GHz band is the only band of the WLAN in which the third client device 206c may be capable of conducting wireless communications, the 2.4 GHz band has superior signal strength for communicating with a location of the third client 206c, or the 2.4 GHz band is has capacity for the type of communications from the third client 206c.

Modifications, additions, or omissions may be made to scenario 200 without departing from the scope of the present disclosure. For example, the number of client devices and/or mesh nodes may vary as compared to those illustrated. Additionally, in some instances, the adaptive node 202 may select the low 5 GHz band for wireless backhaul communications with the mesh node 204 instead of the 6 GHz band (e.g., in instances in which the 6 GHz band communications may be degraded or the 6 GHz band may be otherwise utilized).

Further, in some implementations, due to changes in connectivity or communication requirements, the adaptive node 202 may be configured to change its adaptive radio from communicating in the first mode over the 6 GHz band to communicating in the second mode over the high 5 GHz band. For example, the adaptive radio may transition from the first mode to the second mode in instances in which the mesh node 204 and/or the first client device 206a goes offline with respect to the WLAN. In instances in which the adaptive radio transitions to and operates in the second mode, the adaptive device 202 may conduct 5 GHz communications in the high and/or low 5 GHz bands with client devices and/or other mesh nodes that may support 5 GHz communications, instead of being limited to just the low 5 GHz band in instances in which the adaptive radio of the adaptive node 202 operates in the first mode. In these or other instances, the adaptive radio of the adaptive node 202 may be used to conduct the high 5 GHz band communications and another radio of the adaptive node 202 (e.g., such as the second radio 114 of the adaptive node 100 of FIG. 1A) to conduct the low 5 GHz band communications.

FIG. 3 illustrate an example flowchart of an example method 300 of establishing a mesh backhaul link, described according to at least one implementation of the present disclosure. The method 300 may be performed by any suitable system, apparatus, or device. For example, one or more of the operations of the method 300 may be performed by an adaptive radio module, an adaptive radio, and/or an adaptive node, such as those respectively described above with respect to FIG. 1A. In general, the method 300 may be performed with respect to an adaptive mesh node that is operating in an access point (AP) mode with respect to one or more other mesh nodes that may operate in a station (STA) mode with respect to the adaptive mesh node.

At block 302, it may be determined whether the adaptive mesh node has a wired backhaul connection with one or more other mesh nodes. In response to the adaptive mesh node having a wired backhaul connection (Yes), the method 300 may proceed to block 304. In response to the adaptive mesh node not having a wired backhaul connection (No), the method 300 may proceed to block 310.

At block 304, it may be determined whether the adaptive mesh node is operating in the role of a mesh controller. As indicated above, the mesh controller role may include controlling the operations of one or more other mesh nodes of the WLAN with respect to managing the WLAN. In response to determining that the adaptive mesh node is operating in the role of a mesh controller (Yes), the method 300 may proceed to block 308. In response to determining that the adaptive mesh node is not operating in the role of a mesh controller (No), the method 300 may proceed to block 306.

At block 306, the adaptive mesh node may send (e.g., via the wired backhaul connection) its radio configurations and capabilities to the mesh node that is operating as a mesh controller with respect to the adaptive mesh node. For example, the adaptive mesh node may indicate that it is able to communicate in a first frequency band (e.g., the 6 GHz band), a second frequency band (e.g., the high 5 GHz band), a third frequency band (e.g., the low 5 GHz band), and a fourth frequency band (e.g., the 2.4 GHz band). In these or other implementations, the adaptive mesh node may indicate that it is capable of transitioning between a first mode with respect to the first frequency band and a second mode with respect to the second frequency band. In these or other implementations, the mesh controller may direct the adaptive mesh node as to which frequency bands to use for its corresponding fronthaul and backhaul communications, including which mode in which to operate the adaptive radio. Additionally or alternatively, the adaptive mesh node may determine which frequency bands to use.

At block 308, in response to the adaptive mesh node operating in the role of the mesh controller, the adaptive mesh node may determine as to which frequency bands to use for its corresponding fronthaul and backhaul communications, including which mode in which to operate the adaptive radio. In these or other implementations, the adaptive mesh node may receive the radio configurations and capabilities of one or more other mesh nodes over the wired backhaul connection. Additionally or alternatively, the adaptive mesh node may direct the one or more other mesh nodes as to which frequency bands to use for their corresponding fronthaul and backhaul communications.

At block 310, in response to the adaptive mesh node not having a wired backhaul connection, as determined at block 302, the adaptive mesh node may conduct a wireless backhaul establishment process with one or more STA mesh nodes. Example operations of the wireless backhaul establishment process are given with respect to a process 400 described with respect to FIG. 4.

Modifications, additions, or omissions may be made to the method 300 without departing from the scope of the present disclosure. For example, the order of one or more of the operations described may vary than the order in which they were described or are illustrated. Further, each operation may include more or fewer operations than those described. In addition, the delineation of the operations and elements is meant for explanatory purposes and is not meant to be limiting with respect to actual implementations.

FIG. 4 illustrates an example process 400 of establishing a wireless mesh backhaul link, described according to at least one implementation of the present disclosure. The process 400 may be performed by any suitable system, apparatus, or device. For example, one or more of the operations of the process 400 may be performed by an adaptive radio module, an adaptive radio, and/or an adaptive node, such as those respectively described above with respect to FIG. 1A.

In general, the process 400 may be performed between an adaptive mesh node that is operating in an access point (AP) mode (“adaptive AP node 401”) and a mesh node that is operating in a STA (“STA node 403”) mode with respect to the adaptive AP node 401. In some implementations, the adaptive AP node 401 may be analogous to the adaptive node 100 of FIG. 1A and may accordingly be able to communicate in a first frequency band (e.g., the 6 GHz band), a second frequency band (e.g., the high 5 GHz band), a third frequency band (e.g., the low 5 GHz band), and a fourth frequency band (e.g., the 2.4 GHz band). Additionally or alternatively, the STA node 403 may also be analogous to the adaptive node 100 of FIG. 1A. In these or other implementations, the STA node 403 may be able to communicate in the first frequency band, the second frequency band, the third frequency band, and the fourth frequency band, but not in an adaptive manner.

The process 400 may include operations 402. At operations 402, the adaptive AP node 401 may broadcast one or more beacon signals. For example, in some implementations, the adaptive AP node 401 may be configured to broadcast beacon signals in the first frequency band, the second frequency band, the third frequency band, and/or the fourth frequency band. For instance, in some implementations and in response to having first frequency band communication capabilities, the adaptive AP node 401 may be configured to broadcast beacon signals at a regular interval over one or more channels of the first frequency band. In these or other implementations, the beacon signals may be broadcasted over a preferred scanning channel of the first frequency band. Additionally or alternatively, the beacon signals may be communicated with a Fast-Initial-Link-Setup (FILS). The FILS may include sending FILS frames, which may be reduced size beacon frames, that include a limited set of information associated with the radio configurations and capabilities of the adaptive mesh node. For example, the FILS frames may include server set identifier (SSID) information, basic service set identifier (BSSID) information, and/or channel information associated with the adaptive AP node 401.

Additionally or alternatively, the beacon signals may be broadcast over the third frequency band and/or the fourth frequency band. In these or other implementations, the beacon signals transmitted over the third and/or fourth frequency bands may also include the radio configurations and capabilities of the adaptive AP node 401. For example, frames of such beacon signals may include a reduced neighbor report (RNR) that may include such information.

At operations 404, the STA node 403 may scan for beacon signals that may be broadcast by other mesh nodes such as the adaptive AP node 401. For example, in some implementations, the STA node 403 may listen for beacons transmitted in the first frequency range. In these or other implementations, the STA node 403 may scan through the different channels of the first frequency range to listen for the beacons. In some implementations, the STA node 403 may prioritize the scanning to the preferred scanning channel or channels of the first frequency range, which may improve the speed of discovering the adaptive AP node 401. In these or other implementations, the STA node 403 may listen for beacons in the third and/or fourth frequency ranges.

At operations 408, the STA node 403 may detect the adaptive AP node 401. For example, the STA node 403 may receive one or more of the beacon signals that are transmitted by the adaptive AP node 401 (e.g., by listening on the channel of the transmitted beacon signals). In the present disclosure, reference to “receiving a beacon signal” may include not only the beacon signal exciting a corresponding antenna, but also processing the information included in the beacon signal. In these or other implementations, the STA node 403 may determine that the adaptive AP node is able to communicate in the first frequency band. For example, the STA node 403 may pull such information from the received beacon signals such as from an included RNR and/or SILS frame.

At operations 410, the STA node 403 may communicate a probe request to the adaptive AP node 401. In some implementations, the STA node 403 may send the probe request to the adaptive AP node 401 in response to receiving the one or more beacon signals. In these or other implementations, the STA node 403 may send the probe request over the same channel over which the one or more beacon signals may be received.

Additionally or alternatively, the STA node 403 may broadcast one or more probe requests independently of receiving a beacon signal. In these or other embodiments, the STA node 403 may be configured to broadcast the probe signals over different channels. Additionally or alternatively, the STA node 403 may prioritize broadcasting over a preferred scanning channel, such as that of the first frequency band.

At operations 412, the adaptive AP node 401 may communicate a probe response back to the STA node 403 in response to receiving the probe request. Additionally or alternatively, the STA node 403 may verify whether the received probe response is correct.

At operations 414, the STA node 403 may communicate an authentication request to the adaptive AP node 401. In some implementations, the STA node 403 may send the authentication request in response to receiving the probe response and in response to the probe response being correct.

At operations 416, the adaptive AP node 401 may communicate an authentication response back to the STA node 403 in response to receiving the authentication request. Additionally or alternatively, the STA node 403 may verify whether the received authentication response is correct.

At operations 418, the STA node 403 may communicate an association request to the adaptive AP node 401. In some implementations, the STA node 403 may send the association request in response to receiving the authentication response and in response to the authentication response being correct.

At operations 420, the adaptive AP node 401 may communicate an association response back to the STA node 403 in response to receiving the association request. Additionally or alternatively, the STA node 403 may verify whether the received authentication response is correct.

At operations 422, the adaptive AP node 401 and the STA node 403 may associate with each other. The associating may include the adaptive AP node 401 and the STA node 403 establishing a wireless backhaul connection with each other over a selected frequency band. For example, the adaptive AP node 401 and the STA node 403 may establish the wireless backhaul connection with each other over the first frequency band in response to both having wireless communication capabilities over the first frequency band. In some implementations, such a determination may be made based on the successful communications of the probe signals, the authentication signals, and the association signals.

The associating may also include the adaptive AP node 401 transitioning its adaptive radio according to the selected frequency band for the wireless backhaul communications. For example, in response to the first frequency band being selected, the adaptive radio may transition to a corresponding first mode. Similarly, in response to the second and/or third frequency bands being selected, the adaptive radio may transition to a second mode that corresponds to the second frequency band. In instances in which the STA node 403 also includes an adaptive radio, the adaptive radio of the STA node 403 may similarly transition to the appropriate mode.

Modifications, additions, or omissions may be made to the process 400 without departing from the scope of the present disclosure. For example, the order of one or more of the operations described may vary than the order in which they were described or are illustrated. Further, each operation may include more or fewer operations than those described. In addition, the delineation of the operations and elements is meant for explanatory purposes and is not meant to be limiting with respect to actual implementations.

Additionally, in some instances the STA node 403 may not be able to communicate in the first frequency band. In such instances, the adaptive AP node 401 and the STA node 403 may still associate with each other, but may do so using the second frequency band, the third frequency band, and/or the fourth frequency band. In these or other implementations, the operations related to the probe signals, authentication signals, and association signals with respect to the first frequency band may not be performed.

FIG. 5 illustrates an example flowchart of an example method 500 of transitioning an adaptive radio between operating in a first frequency band and operating in a second frequency band, described according to at least one implementation of the present disclosure. The method 500 may be performed by any suitable system, apparatus, or device. For example, one or more of the operations of the method 500 may be performed by an adaptive radio module, an adaptive radio, and/or an adaptive node, such as those respectively described above with respect to FIG. 1A.

At block 502, a first device may obtain second device information related to capability of a second device with respect to the second device operating in a first frequency band. In some implementations, the first frequency band may correspond to the 802.11 6 GHz band. In these or other implementations, the second device information may be obtained based on beacon signals and/or a wired backhaul connection. Additionally or alternatively, the first device or the second device may be a mesh node device. In these or other implementations, the second device may be a client device.

At block 504, an adaptive radio of the first device may be caused to transition between operating in the first frequency band and operating in a second frequency band based on the second device information. For example, in response to the second device information indicating that the second device is capable of operating in the first frequency band, the adaptive radio may be caused to transition to a first mode associated with operating in the first frequency band. Additionally or alternatively, in response to the second device information indicating that the second device is not capable of operating in the first frequency band, the adaptive radio may be caused to transition to a second mode associated with operating in the second frequency band. In some implementations, the second frequency band may correspond to the 802.11 5 GHz high band.

Modifications, additions, or omissions may be made to the method 500 without departing from the scope of the present disclosure. For example, the order of one or more of the operations described may vary than the order in which they were described or are illustrated. Further, each operation may include more or fewer operations than those described. In addition, the delineation of the operations and elements is meant for explanatory purposes and is not meant to be limiting with respect to actual implementations.

For example, in some implementations, the method 500 may include the first device performing wireless communications with the second device using the adaptive radio. In some instances (e.g., instances in which the second device is a client device), the communications may be fronthaul communications. Additionally or alternatively, the communications may be backhaul communications (e.g., in instances in which the second device is a mesh node device). Further, the beacon signals may be transmitted in any number of frequency bands including the first frequency band, the second frequency band, a third frequency band (e.g., the 802.11 5 GHz low band), and/or a fourth frequency band (e.g., the 802.11 2.4 GHz band). Further, in some implementations, the operations may include performance of backhaul or fronthaul communications with one or more other devices. In these or other implementations, the communications with the one or more other devices may be performed over the third frequency band or the fourth frequency band.

The teachings herein are applicable to any type of wireless communication system or other digital communication systems. For example, while stations and access points are described for one context of wireless communication, the teachings of the use of pre-equalization are also applicable to other wireless communication such as Bluetooth®, Bluetooth Low Energy, Zigbee®, Thread, mmWave, etc.

One skilled in the art will appreciate that, for these and other processes and methods disclosed herein, the functions performed in the processes and methods may be implemented in differing order, simultaneously, etc. Furthermore, the outlined steps and operations are only provided as examples, and some of the steps and operations may be optional, combined into fewer steps and operations, or expanded into additional steps and operations without detracting from the essence of the disclosed implementations.

FIG. 6 illustrates a block diagram of an example computing system 602 that may be used to perform or direct performance of one or more operations described according to at least one implementation of the present disclosure. The computing system 602 may include a processor 650, a memory 652, and a data storage 654. The processor 650, the memory 652, and the data storage 654 may be communicatively coupled.

In general, the processor 650 may include any suitable special-purpose or general-purpose computer, computing entity, or processing device including various computer hardware or software modules and may be configured to execute instructions stored on any applicable computer-readable storage media. For example, the processor 650 may include a microprocessor, a microcontroller, a digital signal processor (DSP), an application-specific integrated circuit (ASIC), a Field-Programmable Gate Array (FPGA), or any other digital or analog circuitry configured to interpret and/or to execute computer-executable instructions and/or to process data. Although illustrated as a single processor, the processor 650 may include any number of processors configured to, individually or collectively, perform or direct performance of any number of operations described in the present disclosure.

In some implementations, the processor 650 may be configured to interpret and/or execute computer-executable instructions and/or process data stored in the memory 652, the data storage 654, or the memory 652 and the data storage 654. In some implementations, the processor 650 may fetch computer-executable instructions from the data storage 654 and load the computer-executable instructions in the memory 652. After the computer-executable instructions are loaded into memory 652, the processor 650 may execute the computer-executable instructions.

The memory 652 and the data storage 654 may include computer-readable storage media for carrying or having computer-executable instructions or data structures stored thereon. Such computer-readable storage media may include any available media that may be accessed by a general-purpose or special-purpose computer, such as the processor 650. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 650 to perform a certain operation or group of operations.

Some portions of the detailed description refer to different modules configured to perform operations. One or more of the modules may include code and routines configured to enable a computing system to perform one or more of the operations described therewith. Additionally or alternatively, one or more of the modules may be implemented using hardware including any number of processors, microprocessors (e.g., to perform or control performance of one or more operations), DSP's, FPGAs, ASICs or any suitable combination of two or more thereof. Alternatively or additionally, one or more of the modules may be implemented using a combination of hardware and software. In the present disclosure, operations described as being performed by a particular module may include operations that the particular module may direct a corresponding system (e.g., a corresponding computing system) to perform. Further, the delineating between the different modules is to facilitate explanation of concepts described in the present disclosure and is not limiting. Further, one or more of the modules may be configured to perform more, fewer, and/or different operations than those described such that the modules may be combined or delineated differently than as described.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of configured operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as detecting, determining, analyzing, identifying, scanning or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. Computer-executable instructions may include, for example, instructions and data which cause a general-purpose computer, special-purpose computer, or special-purpose processing device (e.g., one or more processors) to perform or control performance of a certain function or group of functions.

Although the subject matter has been described in language specific to structural features and/or methodological acts, it is to be understood that the subject matter configured in the appended claims is not necessarily limited to the specific features or acts described above. Rather, the specific features and acts described above are disclosed as example forms of implementing the claims.

An example apparatus can include a Wireless Access Point (WAP) or a station and incorporating a VLSI processor and program code to support. An example transceiver couples via an integral modem to one of a cable, fiber or digital subscriber backbone connection to the Internet to support wireless communications, e.g. IEEE 802.11 compliant communications, on a Wireless Local Area Network (WLAN). The WiFi stage includes a baseband stage, and the analog front end (AFE) and Radio Frequency (RF) stages. In the baseband portion wireless communications transmitted to or received from each user/client/station are processed. The AFE and RF portion handles the upconversion on each of transmit paths of wireless transmissions initiated in the baseband. The RF portion also handles the downconversion of the signals received on the receive paths and passes them for further processing to the baseband.

An example apparatus can be a multiple-input multiple-output (MIMO) apparatus supporting as many as N×N discrete communication streams over N antennas. In an example the MIMO apparatus signal processing units can be implemented as N×N. In various implementations, the value of N can be 4, 6, 8, 12, 16, etc. Extended MIMO operation enables the use of up to 2N antennae in communication with another similarly equipped wireless system. It should be noted that extended MIMO systems can communicate with other wireless systems even if the systems do not have the same number of antennae, but some of the antennae of one of the stations might not be utilized, reducing optimal performance.

Channel State Information (CSI) from any of the devices described herein can be extracted independent of changes related to channel state parameters and used for spatial diagnosis services of the network such as motion detection, proximity detection, and localization which can be utilized in, for example, WLAN diagnosis, home security, health care monitoring, smart home utility control, elder care, automotive tracking and monitoring, home or mobile entertainment, automotive infotainment, and the like.

Unless specific arrangements described herein are mutually exclusive with one another, the various implementations described herein can be combined in whole or in part to enhance system functionality and/or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system, comprising:
an adaptive radio configured to dynamically switch, during run-time in which corresponding hardware or software continues executing operations, between operating in multiple frequency bands to wirelessly communicate with one or more devices over a wireless network; and
a controller configured to direct the adaptive radio to transition, during the run-time, between operating in one of the multiple frequency bands to operating in a selected frequency band of the multiple frequency bands with respect to wirelessly communicating with one or more devices over a wireless network, the transitioning being based on respective capabilities of the one or more devices with respect to operating in the selected frequency band.

2. The system of claim 1, further comprising:
a first other radio configured to operate in a third frequency band; and
a second other radio configured to operate in a fourth frequency band, wherein the controller is configured to direct wireless communications using one or more of: the first other radio or the second other radio while also directing wireless communications using the adaptive radio.

3. The system of claim 2, wherein the multiple frequency bands include:
a first frequency band corresponds to a 6 giga-hertz (GHz) band used in the 802.11 wireless communications standard;
a second frequency band corresponds to a 5 GHz high band used in the 802.11 wireless communications standard;
a third frequency band corresponds to a 5 GHz low band used in the 802.11 wireless communications standard; and
a fourth frequency band corresponds to a 2 GHz band used in the 802.11 wireless communications standard.

4. The system of claim 1, wherein the controller is further configured to:
direct the adaptive radio to transition from operating in a second frequency band of the multiple frequency bands to operating in a first frequency band of the multiple frequency bands for wireless communications with a particular device of the one or more devices based on the respective capability of the particular device with respect to operating in the first frequency band; and
direct performance of the wireless communications with the particular device in the first frequency band using the adaptive radio.

5. The system of claim 1, wherein the controller is further configured to:
direct the adaptive radio to transition from operating in a first frequency band of the multiple frequency bands to operating in a second frequency band of the multiple frequency bands for wireless communications with a particular device of the one or more devices based on the respective capability of the particular device with respect to operating in the first frequency band; and
direct performance of the wireless communications with the particular device in the second frequency band using the adaptive radio.

6. The system of claim 1, wherein the controller is further configured to determine the respective capability of a particular device of the one or more devices with respect to operating in the selected frequency band based on one or more beacon signals.

7. The system of claim 6, wherein the one or more beacon signals are transmitted over one or more of: a first frequency band, a third frequency band, or a fourth frequency band of the multiple frequency bands.

8. A method comprising:
obtaining, by a first mesh node device, second mesh node device information related to a capability of a second mesh node device with respect to operating in a first frequency band; and
in response to determining, based on the obtained second mesh node device information, that the second mesh node device is capable of operating in the first frequency band:
causing an adaptive radio of the first mesh node device to transition, during run-time, from operating in a second frequency band into operating in the first frequency band; and
performing, by the first mesh node device using the adaptive radio, wireless backhaul communications with the second mesh node device in the first frequency band.

9. The method of claim 8, wherein obtaining the second mesh node device information is based on one or more beacon signals.

10. The method of claim 9, wherein the one or more beacon signals are transmitted over one or more of: the first frequency band, a third frequency band, or a fourth frequency band.

11. The method of claim 9, further comprising, transmitting or receiving the one or more beacon signals by the first mesh node device.

12. The method of claim 8, wherein causing the adaptive radio to transition during run-time is without a reset corresponding to hardware or software or performing a power cycle of the first mesh node device.

13. The method of claim 8, further comprising:
obtaining, by the first mesh node device, client device information related to a capability of a client device with respect to operating in the first frequency band; and
in response to determining, based on the obtained client device information, that the client device is capable of operating in the first frequency band:
performing, by the first mesh node device using the adaptive radio, wireless fronthaul communications with the client device in the first frequency band.

14. The method of claim 8, further comprising, directing, by the first mesh node device, the second mesh node device to perform one or more of: the wireless backhaul communications in the first frequency band or one or more wireless fronthaul operations in the first frequency band.

15. The method of claim 8, further comprising, receiving, by the first mesh node device, instructions to perform one or more of: the wireless backhaul communications in the first frequency band or one or more wireless fronthaul operations in the first frequency band.

16. A system comprising:
one or more processors; and
one or more non-transitory computer readable media containing instructions that, when executed by the one or more processors, are configured to cause the system to perform operations, the operations comprising:
obtaining, by a first device, second device information related to a capability of a second device with respect to operating in a first frequency band; and
in response to determining, based on the obtained second device information, that the second device is capable of operating in the first frequency band:
causing an adaptive radio of the first device to transition from operating in a second frequency band into operating in the first frequency band while maintaining run-time operations; and
performing, by the first device using the adaptive radio, wireless communications with the second device in the first frequency band.

17. The system of claim 16, wherein obtaining the second device information is based on one or more beacon signals that are transmitted over one or more of: the first frequency band, a third frequency band, or a fourth frequency band.

18. The system of claim 16, wherein the first device is a mesh node device and the second device is a client device.

19. The system of claim 16, wherein the first device is a first mesh node device and the second device is a second mesh node device.

20. The system of claim 16, the operations further comprising, performing, by the first device using an other radio, wireless communications with a third device in a third frequency band.
